(19) United States
(12) Patent Application Publication
(10) Pub. No.: US 2017/0241563 A1
(43) Pub. Date: Aug. 24, 2017

(54) VALVE ASSEMBLY AND METHOD

(71) Applicant: Caterpillar Global Mining America LLC, Houston, PA (US)

(72) Inventor: Steven Allen Simpson, Steubenville, OH (US)

(73) Assignee: Caterpillar Global Mining America LLC, Houston, PA (US)

(21) Appl. No.: 15/048,344

(22) Filed: Feb. 19, 2016

(51) Int. Cl. F16K 31/122; E21C 35/23; F16K 1/12

(52) U.S. Cl. CPC F16K 31/1221; F16K 1/126; E21C 35/23; E21C 2035/226

(57) ABSTRACT

The present disclosure is related to a valve assembly. The valve assembly includes a housing defining an inlet port and an outlet port. The outlet port extends along a longitudinal axis of the housing to enable a fluid flow through the outlet port in a first direction. The valve assembly includes a valve element at least partially located within the housing and movable along the longitudinal axis between a first position in which the outlet port is closed and a second position in which the outlet port is open. The valve assembly includes a biasing member located within the housing and configured to bias the valve element to the first position. The direction of movement of the valve element from the first position to the second position is generally opposite to the first direction.

### TECHNICAL FIELD

The present disclosure relates to a valve assembly and a method for operating the valve assembly.

### BACKGROUND

Machines, such as continuous miners, include one or more liquid valves in order to regulate flow of liquid to various components. In continuous miners, liquid valves control flow of liquid to one or more spray nozzles that spray water or other appropriate liquids onto cutting elements and mining surface to suppress dust and eliminate any risk of frictional ignition as the cutting elements strike the solid material. The liquid valves are typically arranged within manifolds in combination with other hydraulic components.

Such a liquid valve includes an inlet port, an outlet port, and a poppet that moves between an open position in which the outlet port is open and a closed position in which the outlet port is closed. Typically, a direction of flow through the outlet port is perpendicular to the movement of the poppet. However, such an arrangement may require the ports to be positioned in a manner that is unsuitable for combining the liquid valve with the other hydraulic components within the manifold.

U.S. Patent Application No. 2015/0168959 A1 (the '959 reference) discloses a flow control valve that is provided with an inflow side block which is provided with a main inflow part, an inflow side chamber, and an intermediate outflow part. The flow control valve also includes an outflow side block which is provided with an intermediate inflow part, an outflow side chamber, a valve seat, and a main outflow part. The flow control valve further includes a connection block which connects the inflow side block and the outflow side block, a connection flow path which connects the intermediate outflow part and the intermediate inflow part, a pressure differential device part, a first diaphragm to which a constant pressure is applied at all times, and a second diaphragm which is provided with a valve element which operates to advance and retract with respect to a valve seat. The connection block has a connection chamber which holds a transmission member which can transmit fluctuation of one diaphragm to the other.

### SUMMARY OF THE DISCLOSURE

In an aspect of the present disclosure, a valve assembly is provided. The valve assembly includes a housing defining an inlet port and an outlet port. The outlet port extends along a longitudinal axis of the housing to enable a fluid flow through the outlet port in a first direction. The valve assembly includes a valve element at least partially located within the housing and movable along the longitudinal axis between a first position in which the outlet port is closed and a second position in which the outlet port is open. The valve assembly includes a biasing member located within the housing and configured to bias the valve element to the first position. The direction of movement of the valve element from the first position to the second position is generally opposite to the first direction.

In another aspect of the present disclosure, a valve assembly is provided. The valve assembly includes a housing defining an inlet port, an outlet port and an actuation port. The outlet port extends along a longitudinal axis of the housing to enable a fluid flow through the outlet port in a first direction. The housing further includes a valve seat adjacent to the outlet port. The valve assembly further includes a dividing member disposed within the housing and configured to divide the housing into a fluid chamber and an actuating chamber. The outlet port is in fluid communication with the fluid chamber and the actuation port is in fluid communication with the actuating chamber. The valve assembly also includes a valve element slidably arranged through the dividing member and movable along the longitudinal axis between a first position and a second position. In the first position, the valve element is configured to engage with the valve seat of the housing to prevent fluid flow between the fluid chamber and the outlet port. In the second position, the valve element is disengaged from the valve seat to allow fluid flow between the fluid chamber and the outlet port. The valve assembly further includes a biasing member received between the dividing member and the valve element. The biasing member is configured to bias the valve element to the first position. The valve element is configured to be selectively moved to the second position by pressure of actuating fluid received through the actuation port. The direction of movement of the valve element from the first position to the second position is generally opposite to the first direction

In yet another aspect of the present disclosure, a method of operating a valve assembly is disclosed. The valve assembly includes a housing defining an inlet port and an outlet port, and a valve element at least partially located within the housing. The outlet port extends along a longitudinal axis of the housing to enable a fluid flow through the outlet port in a first direction. The method includes biasing the valve element to a first position in which the outlet port is closed. The method further includes selectively moving the valve element along the longitudinal axis from the first position to a second position in which the outlet port is open. The direction of movement of the valve element from the first position to the second position is generally opposite to the first direction.

### BRIEF DESCRIPTION OF THE DRAWINGS

FIG. 1 is a partial perspective view of an exemplary machine;

FIG. 2 is a sectional view of a valve assembly of the machine in a closed position, according to an embodiment of the present disclosure;

FIG. 3 is a sectional view of the valve assembly of FIG. 2 in an open position; and

FIG. 4 is a flowchart for a method of operating the valve assembly FIG. 1, according to an embodiment of the present disclosure.

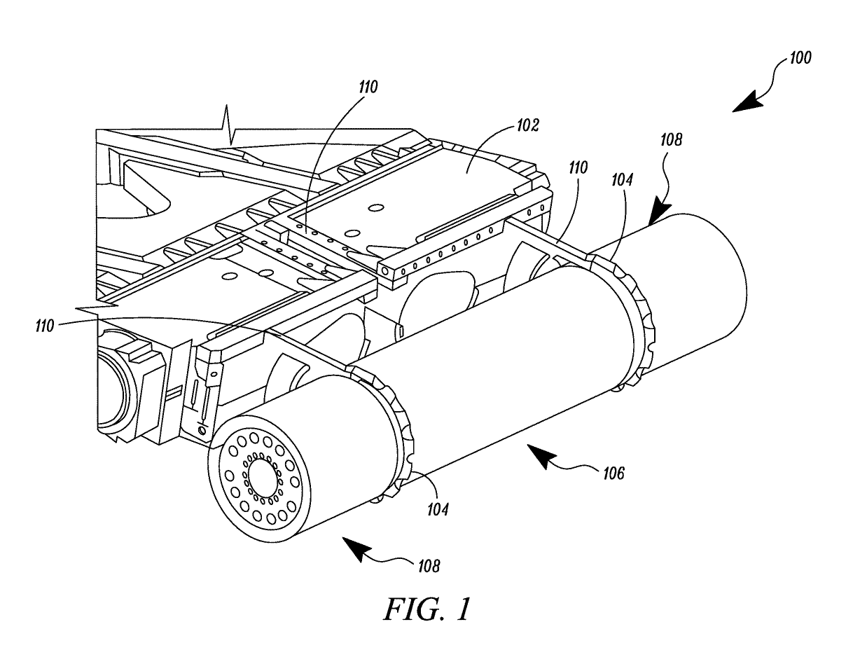

### DETAILED DESCRIPTION

Wherever possible, the same reference numbers will be used throughout the drawings to refer to the same or the like parts. Referring to FIG. 1, an exemplary machine 100 is illustrated. In the illustrated embodiment, the machine 100 is a continuous mining machine. However, in alternative embodiments, the machine 100 may be any other type of machine known in the art, for example, but not limited to, a loader, a dozer, a mining truck, a water truck, and an excavator. The machine 100 may also be used in various applications, such as mining, construction, power generation, agriculture, transportation etc.

As illustrated in FIG. 1, the machine 100 includes a body portion 102 and boom members 104 extending forwardly from the body portion 102. The boom members 104 may be connected to or integral with portions of a gear and bearing housing (not shown) configured to support gear assemblies and bearing assemblies. Rotating cutter drum assemblies 106, 108 are rotatably mounted on the gear and bearing housing connected to the boom members 104. Cutting elements (not shown) may be secured around portions of the outer peripheries of the rotating cutter drum assemblies 106, 108 and extend therefrom. The cutting elements may be provided with hardened tips that contact the mining surface as the machine 100 moves the rotating cutter drum assemblies 106, 108 into contact with the mining surface to remove material. Each cutting element may also be provided with one or more liquid spray nozzles that are configured to spray water or other appropriate liquids onto the cutting elements and mining surface to suppress dust and reduce the chance of frictional ignition as the cutting elements strike solid material. Though FIG. 1 illustrates cutting components of the machine 100, it may be apparent to a person of ordinary skill in the art that the machine 100 may further include additional modules, for example, but not limited to, a conveyor module (not shown), a shovel module (not shown) and an operator cabin (not shown).

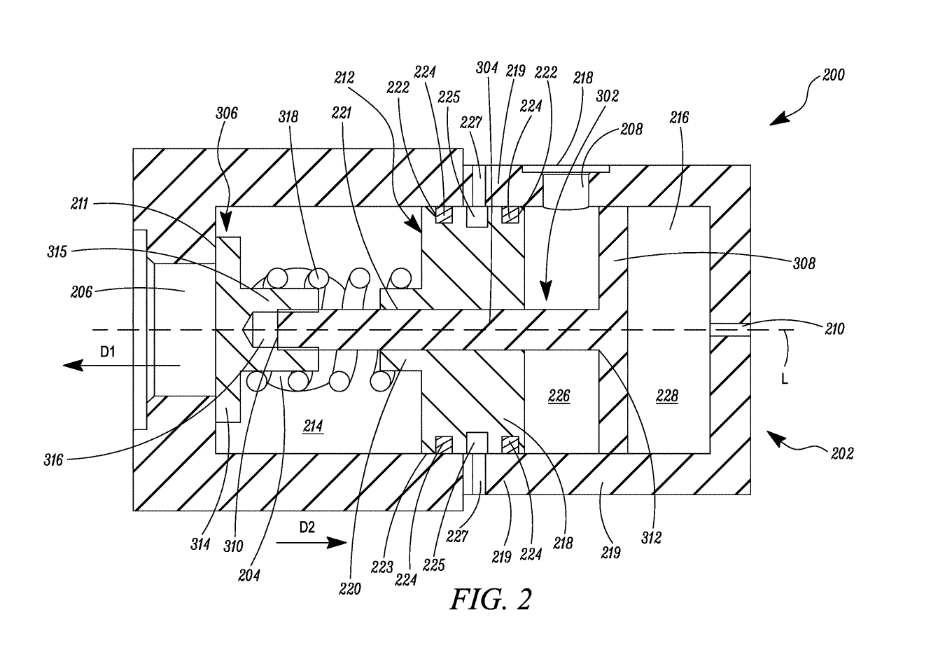

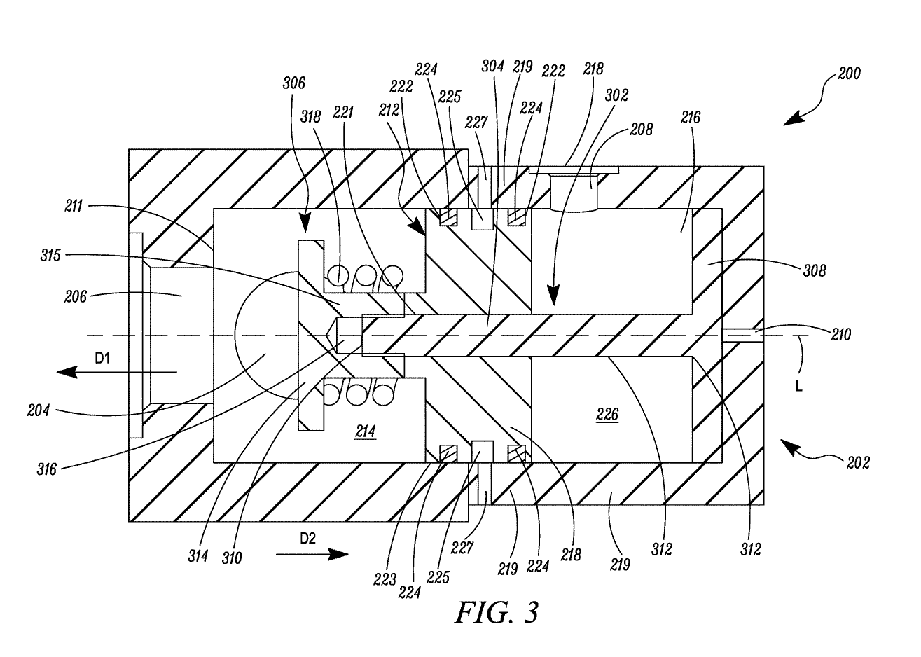

The machine 100 also includes manifolds 110 extending along the boom members 104 and configured to convey liquid from the body portion 102 of the machine 100 to the rotating cutter drum assemblies 106, 108 and the cutting elements secured to the rotating cutter drum assemblies 106, 108. Each of the manifolds 110 may include various components, such as liquid passageways, valves, reservoirs, and the like. Each of the manifolds 110 may also be in fluid communication with a hydraulic module (not shown) of the machine 100 for actuation of one or more components, such as the valves. In an embodiment, one or more of the manifolds 110 may include a valve assembly 200 which will be described hereinafter in greater detail with reference to FIGS. 2 and 3. It may also be contemplated that one or more of the manifolds 110 may include multiple valve assemblies 200.

FIGS. 2 and 3 illustrate the valve assembly 200 in a closed position and an open position, respectively. The valve assembly 200 includes a housing 202 defining an inlet port 204, an outlet port 206, an actuation port 208 and a balancing port 210. The outlet port 206 extends along a longitudinal axis ‘L’ of the housing 202 to enable a fluid flow through the outlet port 206 in a first direction ‘D1’. Further, the inlet port 204 extends in a direction radial to the longitudinal axis ‘L’ of the housing 202. The housing 202 further includes a valve seat 211 adjacent to the outlet port 206.

The valve assembly 200 further includes a dividing member 212 disposed within the housing 202 and configured to divide the housing 202 into a fluid chamber 214 and an actuating chamber 216. The inlet port 204 is in fluid communication with the fluid chamber 214. The outlet port 206 is in fluid communication with the fluid chamber 214 when the valve assembly 200 is in the open position. The dividing member 212 includes a base portion 218 supported between walls 219 of the housing 202 and may include a support section 220 extending into the fluid chamber 214 in the first direction ‘D1’. Further, the base portion 218 and, where present, the support section 220 together define an aperture 221 extending between the fluid chamber 214 and the actuating chamber 216. The base portion 218 may be coupled to the walls 219 by various methods, such as press-fitting, welding, adhesives, and the like. The base portion 218 also defines a pair of grooves 222 along an outer circumference 223 that interfaces with the walls 219. Each of the grooves 222 is configured to receive a sealing member 224 therein. The sealing member 224 is configured to fluidly isolate the fluid chamber 214 from the actuating chamber 216. In an embodiment, the sealing member 224 is an O-ring. The base portion 218 further defines a vent groove 225 along the outer circumference 223. The vent groove 225 is located between the grooves 222 and fluidly communicates with vent passages 227 defined in the wall 219 of the housing 202. In case of any leakage of fluid across the sealing members 224, the vent groove 225 may collect the leaked fluid and allow the leaked fluid to flow through the vent passages 227. This may prevent flow of any leaked fluid from one the fluid or actuating chambers 214, 216 to the other chamber.

The valve assembly 200 also includes a valve element 302 at least partially located in the housing 202. The valve element 302 is movable along the longitudinal axis 1′ between a first position (as shown in FIG. 2) in which the outlet port 206 is closed and a second position (as shown in FIG. 3) in which the outlet port 206 is open. Further, a direction of movement, shown as a second direction ‘D2’, of the valve element 302 from the first position to the second position is generally opposite to the first direction ‘D1’.

The valve element 302 includes a stem portion 304, a plug portion 306 and an actuating portion 308. The stem portion 304 is an elongate member slidably received through the aperture 221 of the dividing member 212 and configured to slide along the longitudinal axis ‘L’. In an embodiment, a sealing element (not shown) may be provided in a sliding interface between the dividing member 212 and the stem portion 304 in order to fluidly isolate the fluid chamber 214 from the actuating chamber 216. The stem portion 304 includes a first end 310 disposed within the fluid chamber 214 and a second end 312 disposed within the actuating chamber 216. The plug portion 306 is disposed at the first end 310 of the stem portion 304. The plug portion 306 includes a sealing section 314 configured to engage with the valve seat 211 (as shown in FIG. 2) of the housing 202 to prevent fluid flow between the fluid chamber 214 and the outlet port 206. The plug portion 306 may include a connecting section 315 extending from the sealing section 314 in the second direction ‘D2’. The connecting section 315 defines an opening 316 configured to receive the first end 310 of the stem portion 304. In the illustrated embodiment, the plug portion 306 is a separate component and the connecting section 315 of the plug portion 306 may be coupled to the stem portion 304 by various methods, such as threads, press-fitting, welding, adhesives, and the like. However, in an alternative embodiment, the plug portion 306 may be integral with the stem portion 304.

The actuating portion 308 is a generally disc shaped member extending radially from the second end 312 of the stem portion 304 and configured to divide the actuating chamber 216 into a first portion 226 and a second portion 228. However, a shape of the actuating portion 308 may vary with a shape of the housing 202. Further, the actuating portion 308 may include an additional sealing element (not shown) in order to fluidly isolate the first portion 226 from the second portion 228. The actuation port 208 is in fluid communication with the first portion 226 of the actuating chamber 216, while the balancing port 210 is in fluid communication with the second portion 228 of the actuating chamber 216.

The valve assembly 200 further includes a biasing member 318 located within the housing 202 and configured to bias the valve element 302 to the first position. In the illustrated embodiment, the biasing member 318 is a coil spring disposed between between the support section 220 of the dividing member 212 and the sealing section 314 of the plug portion 306. However, the biasing member 318 may be any other type of resilient element, for example, a gas spring, a volute spring etc.

Referring to FIGS. 1 to 3, the inlet port 204 of the valve assembly 200 may be connected to a source of liquid (for example, a reservoir) located within or in fluid communication with one of the manifolds 110. Liquid from the source flows into the fluid chamber 214 via the inlet port 204. The outlet port 206 may be in fluid communication with one or more spray nozzles of the machine 100. In the first position of the valve element 302, the sealing section 314 of the plug portion 306 is engaged with the valve seat 211 and prevents fluid flow between the fluid chamber 214 and the outlet port 206. The actuation port 208 may be selectively in fluid communication with a source of actuating fluid (for example, an accumulator of the hydraulic module). In an embodiment, actuating fluid may be hydraulic fluid associated with the hydraulic module of the machine 100. In an alternative embodiment, actuating fluid may be water or any other fluid.

In an embodiment, a control valve (not shown) may regulate flow of actuating fluid from the source to the actuation port 208. The control valve may be an electronically controlled valve communicably coupled to a control module of the machine 100. In the first position of the valve element 302, the control valve may block flow of actuating fluid to the actuation port 208. In an embodiment, the control valve may fluidly communicate the actuation port 208 and the balancing port 210 with a tank (not shown) such that pressure in the first portion 226 is substantially equal to pressure in the second portion 228. Therefore, forces on both sides of the actuating portion 308 of the valve element 302 are balanced and the valve element 302 is biased to the first position by the biasing member 318. Alternatively, the control valve may connect the balancing port 210 to a source of pressurized actuating fluid (for example, a pump or an accumulator) and connect the actuation port 208 to the tank. As a result, a pressure of actuating fluid in the second portion 228 of the actuating chamber 216 may be higher than a pressure in the first portion 226. The actuating portion 308 may therefore experience a resultant force which biases the valve element 302 to the first position. Hence, higher pressure in the second portion 228 may assist the biasing member 318 in retaining the valve element 302 in the first position.

The valve element 302 may be selectively moved from the first position to the second position in order to allow fluid flow from the fluid chamber 214 to the outlet port 206. The control valve may be electronically controlled by the control module of the machine 100, based on a user input or a set of preset instructions, to fluidly communicate the actuation port 208 to the source of pressurized fluid, and fluidly communicate the balancing port 210 with the tank. Hence, actuating fluid, flowing into the first portion 226 of the actuating chamber 216 via the actuation port 208, may be at a pressure higher than the pressure in the second portion 228. A resultant force acting on the actuating portion 308 of the valve element 302 may overcome the biasing of biasing member 318. Consequently, the valve element 302 moves to the second position in the second direction ‘D2’, and the sealing section 314 disengages from the valve seat 211 (as shown in FIG. 3). This allows fluid flow between the fluid chamber 214 and the outlet port 206, and liquid flows through the outlet port 206 in the first direction ‘D1’. Liquid flowing through the outlet port 206 may be supplied to one or more spray nozzles configured to dispense liquid to aid a cutting operation of the machine 100.

In order to move the valve element 302 back to the first position, the control valve may fluidly communicate the actuation port 208 to the tank and the balancing port 210 to the source of pressurized fluid. The pressures in the second portion 228 may become higher than the pressure in the first portion 226. As a result, the actuating portion 308 may experience a resultant force which biases the valve element 302 to the first position. The valve element 302 may therefore move to the first position due to the biasing of the biasing member 318 and the resultant force acting on the actuating portion 308.

Details of the valve assembly 200, as described above, are purely exemplary in nature and variations are possible within the scope of the present disclosure. For example, the valve assembly 200 may include multiple inlet ports 204, outlet ports 206, actuation ports 208 and balancing ports 210. Location of each of the ports may also differ as long as the ports communicate with the respective chambers, and the outlet port 206 extends in the first direction ‘D1’. The valve assembly 200 may also be used in alternative applications, for example, controlling flow of hydraulic fluid in the hydraulic module of the machine 100.

### INDUSTRIAL APPLICABILITY

A valve assembly is provided within a manifold of a machine to control flow of a liquid, such as water. The valve assembly is combined with other components of the manifold, such as other valves. Position of one or more ports of the valve assembly may not be suitable for combination with the other components within the manifold.

The present disclosure is related to the valve assembly 200 that includes the outlet port 206 extending in the first direction ‘D1’, and the valve element 302 moving from the first position to the second position in the second direction ‘D2’ which is opposite to the first direction ‘D1’. The valve element 302 is biased by the biasing member 318 to the first position and moved to the second position by pressure of actuating fluid received through the actuation port 208.

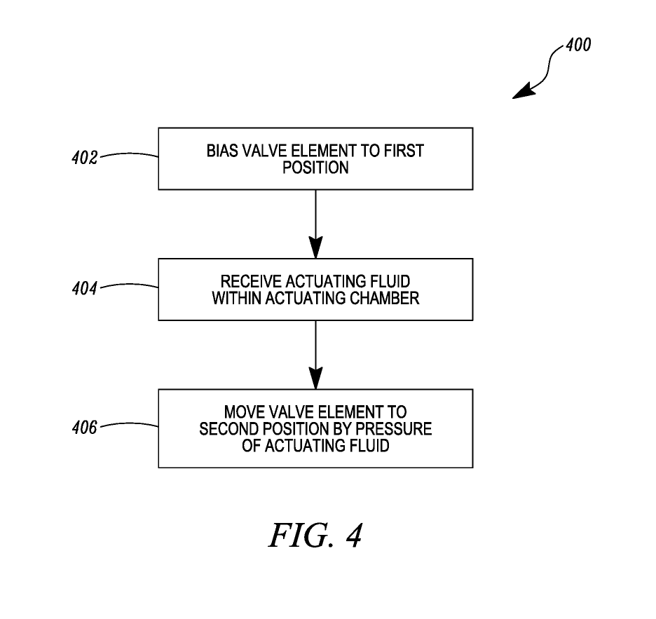

Referring to FIGS. 1 to 4, the present disclosure is also related to a method 400 of operating the valve assembly 200. At step 402, the method 400 includes biasing the valve element 302, via the biasing member 318, to the first position in which the outlet port 206 is closed due to engagement between the sealing section 314 of the plug portion 306 and the valve seat 211. At step 404, the method 400 includes receiving actuating fluid, through the actuation port 208, within the actuating chamber 216 of the housing 202. Specifically, actuating fluid is received in the first portion 226 of the actuating chamber 216. The control valve may fluidly communicate the actuation port 208 with the source of actuating fluid based on a user input or an automatically generated signal in order to supply the first portion 226 with actuating fluid. At step 406, the method 400 includes moving the valve element 302 from the first position to the second position in the second direction ‘D1’ by pressure of actuating fluid.

The valve assembly 200 and the method 400 of the present disclosure may enable the direction of movement of the valve element 302 from the first position to the second position to be generally opposite to the first direction ‘D1’. Such an arrangement may facilitate combination of the valve assembly 200 with various components, such as other valves, within one or more of the manifolds 110 of the machine 100.

While aspects of the present disclosure have been particularly shown and described with reference to the embodiments above, it will be understood by those skilled in the art that various additional embodiments may be contemplated by the modification of the disclosed systems and methods without departing from the spirit and scope of what is disclosed. Such embodiments should be understood to fall within the scope of the present disclosure as determined based upon the claims and any equivalents thereof.

What is claimed is:

1. A valve assembly comprising:
a housing defining an inlet port and an outlet port, the outlet port extending along a longitudinal axis of the housing to enable a fluid flow through the outlet port in a first direction;
a valve element at least partially located within the housing and movable along the longitudinal axis between a first position in which the outlet port is closed and a second position in which the outlet port is open; and
a biasing member located within the housing and configured to bias the valve element to the first position,
wherein the direction of movement of the valve element from the first position to the second position is generally opposite to the first direction.

2. The valve assembly of claim 1, further comprising a dividing member disposed within the housing and configured to divide the housing into a fluid chamber and an actuating chamber, wherein the outlet port is in fluid communication with the fluid chamber in the second position of the valve element.

3. The valve assembly of claim 2, wherein the housing further defines an actuation port in fluid communication with the actuating chamber.

4. The valve assembly of claim 3, wherein the valve element comprises:
a stem portion slidably received through the dividing member, the stem portion having a first end disposed within the fluid chamber and a second end disposed within the actuating chamber;
a plug portion disposed at the first end of the stem portion, the plug portion configured to engage with a valve seat of the housing to prevent fluid flow between the fluid chamber and the outlet port; and
an actuating portion disposed at the second end of the stem portion, the actuating portion configured to divide the actuating chamber into a first portion and a second portion, wherein the actuation port is in fluid communication with the first portion of the actuating chamber, and wherein the actuating portion is moved by pressure of actuating fluid received within the first portion of the actuating member.

5. The valve assembly of claim 4, wherein the actuating portion is a disc radially extending from the stem portion.

6. The valve assembly of claim 4, wherein the plug portion comprises:
a sealing section configured to engage with the valve seat; and
a connecting section extending from the sealing section in a direction opposite to the first direction, the connecting section defining an opening configured to receive the first end of the stem portion therein, wherein the connecting section is coupled to the stem portion.

7. The valve assembly of claim 6, wherein the dividing member comprises a support section extending into the fluid chamber along the first direction, wherein the biasing member is disposed between the support section and the sealing section of the plug portion.

8. The valve assembly of claim 4, wherein the housing further defines a balancing port in fluid communication with the second portion of the actuating chamber.

9. The valve assembly of claim 2, wherein the dividing member further defines a groove along an outer circumference thereof, the groove configured to receive a sealing member therein.

10. The valve assembly of claim 1, wherein the inlet port extends in a direction radial to the longitudinal axis of the housing.

11. A valve assembly comprising:
a housing defining an inlet port, an outlet port and an actuation port, the outlet port extending along a longitudinal axis of the housing to enable a fluid flow through the outlet port in a first direction, the housing further comprising a valve seat adjacent to the outlet port;
a dividing member disposed within the housing and configured to divide the housing into a fluid chamber and an actuating chamber, wherein the outlet port is selectively in fluid communication with the fluid chamber and the actuation port is in fluid communication with the actuating chamber;
a valve element slidably arranged through the dividing member and movable along the longitudinal axis between a first position and a second position, wherein, in the first position, the valve element is configured to engage with the valve seat of the housing to prevent fluid flow between the fluid chamber and the outlet port, and wherein, in the second position, the valve element is disengaged from the valve seat to allow fluid flow between the fluid chamber and the outlet port; and
a biasing member received between the dividing member and the valve element, the biasing member configured to bias the valve element to the first position,
wherein the valve element is configured to be selectively moved to the second position by pressure of actuating fluid received through the actuation port, and wherein the direction of movement of the valve element from the first position to the second position is generally opposite to the first direction.

12. The valve assembly of claim 11, wherein the inlet port extends in a direction radial to the longitudinal axis of the housing.

13. The valve assembly of claim 11, wherein the valve element comprises:
a stem portion slidably received through the dividing member, the stem portion having a first end disposed within the fluid chamber and a second end disposed within the actuating chamber;
a plug portion disposed at the first end of the stem portion, the plug portion configured to engage with the valve seat of the housing to prevent fluid flow between the fluid chamber and the outlet port; and
an actuating portion disposed at the second end of the stem portion, the actuating portion configured to divide the actuating chamber into a first portion and a second portion, wherein the actuation port is in fluid communication with the first portion of the actuating chamber, and wherein the actuating portion is moved by pressure of actuating fluid received within the first portion of the actuating member.

14. The valve assembly of claim 13, wherein the actuating portion is a disc radially extending from the stem portion.

15. The valve assembly of claim 13, wherein the plug portion comprises:
a sealing section configured to engage with the valve seat; and
a connecting section extending from the sealing section in a direction opposite to the first direction, the connecting section defining an opening configured to receive the first end of the stem portion therein, wherein the connecting section is coupled to the stem portion.

16. The valve assembly of claim 15, wherein the dividing member comprises a support section extending into the fluid chamber along the first direction, wherein the biasing member is disposed between the support section and the sealing section of the plug portion.

17. The valve assembly of claim 13, wherein the housing further defines a balancing port in fluid communication with the second portion of the actuating chamber.

18. The valve assembly of claim 11, wherein the dividing member further defines a groove along an outer circumference thereof, the groove configured to receive a sealing member therein.

19. A method of operating a valve assembly having a housing defining an inlet port and an outlet port, and a valve element at least partially located within the housing, the outlet port extending along a longitudinal axis of the housing to enable a fluid flow through the outlet port in a first direction, the method comprising:
biasing the valve element to a first position in which the outlet port is closed; and
selectively moving the valve element along the longitudinal axis from the first position to a second position in which the outlet port is open, wherein the direction of movement of the valve element from the first position to the second position is generally opposite to the first direction.

20. The method of claim 19, further comprising:
receiving actuating fluid within an actuating chamber of the housing; and
moving the valve element to the second position by pressure of actuating fluid.
